(19) United States
(12) Patent Application Publication
(10) Pub. No.: US 2023/0275263 A1
(43) Pub. Date: Aug. 31, 2023

(54) Method for manufacturing a solid-state battery

(71) Applicant: Oerlikon Surface Solutions AG, Pfäffikon, Pfäffikon (CH)

(72) Inventor: Siva Phani Kumar Yalamanchili, Sargans (CH)

(21) Appl. No.: 18/014,228

(22) PCT Filed: Jul. 2, 2021
(86) PCT No.: PCT/EP2021/068336

§ 371 Date: Jan. 3, 2023

(30) Foreign Application Priority Data
Jul. 3, 2020 (EP) 20000240.0

(51) Int. Cl. H01M 10/0562

(52) U.S. Cl. CPC H01M 10/0562; H01M 2300/0071; H01M 2300/0094; H01M 2300/0068

(57) ABSTRACT

The invention relates to a method for manufacturing a solid-state battery (2) comprising the steps of preparing (100) a cathode (4), preparing (400) an anode (6), and preparing (200) a solid-state electrolyte (8) to be disposed between the cathode (4) and the anode (6), wherein the solid-state electrolyte (8) is prepared by means of a coating process, wherein the coating process comprises PVD coating.

The invention relates to a method for manufacturing a solid-state battery and to a solid-state battery, in particular manufactured by a method according to the invention.

Rechargeable batteries have developed steadily in recent years and can now be used in a variety of ways. In addition to their use in hybrid or electric vehicles, rechargeable batteries are also known to be used to store electricity from renewable sources. The batteries have an anode, a cathode and an electrolyte. In addition to different anode and cathode materials, the electrolytes used can also vary. Today's batteries for use in hybrid or electric vehicles usually have liquid or gel-like electrolytes. The liquids suitable as electrolytes have the disadvantage that they are easily flammable and thus represent a major safety risk. The electrolytes can leak out of the batteries and be ignited by heat or a short circuit or similar. Especially in vehicle construction, such scenarios are not uncommon in accidents.

For this reason, approaches are known to replace the flammable liquid electrolytes with solid, non-flammable electrolytes as part of the introduction of solid-state batteries. Disadvantageously, the solid-state batteries with solid-state electrolytes produced via the processes known so far have some serious disadvantages.

In particular, the contact surface between the electrodes and the solid-state electrolyte in the known solid-state batteries is only small, which leads, among other things, to low chemical and electrochemical stabilities of such batteries. In addition, the known solid-state electrolytes generally have only low ionic mobilities and voltage acceptance ranges. Furthermore, the production of the required thin electrolyte layers and thin anode layers is difficult in terms of process technology. Furthermore, the problem of anode swelling and uneven lithium deposition often occurs in the solid-state batteries produced using the known processes. The latter can ultimately lead to undesired dendrite growth and thus to the destruction of a solid-state battery.

It is therefore the object of the present invention to at least partially overcome the disadvantages described above. In particular, it is the object of the present invention to provide a process for the production of a solid-state battery which can be carried out in a simple and inexpensive manner and which enables the production of long-lasting and reliably and stably operable high-performance batteries which can be used variably.

The problem is solved by a method having the features of claim 1, a solid-state battery having the features of claim 9 and a motor vehicle having the features of claim 18. Further features and details of the invention result from the dependent claims, the description and the drawings. Features and details described in connection with the method according to the invention naturally also apply in connection with the solid-state battery according to the invention or the motor vehicle according to the invention and vice versa in each case, so that reference is or can always be made mutually to the individual aspects of the invention with regard to the disclosure.

According to the invention, a method for manufacturing a solid-state battery is provided. The method according to the invention comprises the steps of preparing a cathode, preparing an anode, and preparing a solid-state electrolyte to be disposed between the cathode and the anode. The method according to the invention is further characterized in that the solid-state electrolyte is prepared by means of a coating process, wherein the coating process comprises PVD coating.

Thus, according to the invention, it is provided that at least a solid-state electrolyte according to the invention is produced via a coating process in a manufacturing process of a solid-state battery, wherein the coating process-comprises PVD coating. In contrast to known methods for the production of solid-state batteries, the production of the solid-state electrolyte according to the invention by means of a coating process makes it possible to enlarge the interfaces between the electrodes and the solid-state electrolyte. In addition, by using a coating process, in particular a PVD coating process, it is possible to produce thin electrode structures with high electrical conductivity, whereby the possible voltage range is not reduced. The functioning of the process according to the invention, in particular the interaction of the individual steps of the process according to the invention, is explained in more detail below.

Preferably, the coating process is formed as a PVD coating process, in particular as a reactive PVD coating process, such as a high-performance pulsed magnetron sputtering process or reactive arc deposition or the like. The solid-state battery produced according to the process of the invention can preferably be used in motor vehicles, in particular in electric vehicles. However, it is understood that the solid-state battery produced according to the method according to the invention can also be used in other battery-powered vehicles or stationary devices. In the context of the invention, a solid-state battery can preferably be understood as a battery in which the electrolyte is formed from a solid material, the solid-state electrolyte. In particular, the solid-state battery can be designed as a solid-state accumulator. In the context of the invention, a solid-state electrolyte can also be understood as a solid material, i.e. in particular a material that is solid at the present operating temperatures, by means of which ions can be conducted so that an electric current carried by the ions flows.

Within the scope of a particularly precisely and purposefully controllable production even of particularly thin cathode layers, it can be advantageously provided according to the invention that the cathode is prepared by a thermal deposition process, preferably by a thermal spray deposition process.

In the context of a particularly precisely and purposefully controllable production of thin anode layers, it can also be advantageously provided in accordance with the invention that the anode is prepared by a PVD coating process, wherein the preparation preferably comprises laser surface structuring and/or 3D-texturing.

In order to optimize the contact surface between the electrodes and the solid-state electrolyte, it may further be provided that the method comprises preparing at least one contact layer for improving a contact between the cathode and the solid-state electrolyte and/or between the anode and the solid-state electrolyte, wherein the contact layer preferably comprises a lithium compound, wherein the contact layer in particular is formed in the form of a lithium alloy. Such an optimized contact surface enables, in particular, improved chemical and electrochemical stability of a solid-state battery. The contact layer thereby preferably should be located between the electrode layers and the solid-state electrolyte.

In the context of a purposefully modifiable contact layer, according to the invention, it can further be provided that the contact layer is prepared by means of a PVD coating process, preferably by means of an arc deposition process and/or a magnetron-sputtering process, in particular a high-power pulsed magnetron-sputtering process.

In the context of a simple, fast and cost-optimized production, it can also be provided according to the invention that the cathode, the solid-state electrolyte and the anode are prepared one after another, wherein the cathode, the solid-state electrolyte and the anode preferably each being prepared by means of an application process, the cathode in particular being applied first, before the solid-state electrolyte is applied on the cathode and the anode is then applied on the solid-state electrolyte. The application processes can be particularly well coordinated with one another in this way. The application processes can preferably be carried out as a coating process, in particular as a PVD coating process. Alternatively, it can also be provided that only the solid-state electrolyte is produced by means of a coating process comprising a PVD process and the cathode and anode are connected to the solid-state electrolyte after their production by means of other processes.

With regard to the possibility of a targeted adaptation of the structures of cathode, anode and solid-state electrolyte, in particular the increase of the conductivity of the solid-state electrolyte, it is conceivable that the method comprises at least one post-processing step, wherein the post-processing step preferably comprises at least one of the following steps:
a microalloying,
a stoichiometric tuning,
a microstructural tuning,
a metastable phase formation.

Microalloying can be understood in particular as a process in which minimal additions of further metals, e.g. up to 0.1% by weight of the total mass, are added to a metal or an alloy. Stoichiometric tuning can also be understood as a targeted adjustment of stoichiometric ratios. Microstructural adjustment can also be understood as a targeted adjustment of structural ratios. Finally, metastable phase formation can be understood as a targeted adjustment of metastable phases. Post-processing can be carried out in particular following the application or preparation of the solid-state electrolyte.

Within the scope of a particularly flexibly adjustable structure as well as a flexible adaptation of individual process steps, it can also be provided that the method comprises different deposition techniques, preferably combining thin film deposition techniques and thick film deposition techniques, wherein the method in particular comprises at least one of a spray deposition technique and/or an arc deposition technique and/or a magnetron sputter deposition technique and/or a reactive PVD deposition technique and/or a pulsed laser deposition technique and/or a hot calendering technique. Furthermore, also techniques as PLD, or the like can be used.

Another object of the invention is a solid-state battery, in particular produced by means of the aforementioned method. According to the invention, the solid-state battery comprises a cathode, an anode, and a solid-state electrolyte disposed between the cathode and the anode, wherein the solid-state electrolyte is in the form of a PVD coating structure. Thus, the solid-state battery according to the invention also shows the same advantages as have already been described in detail with reference to the process according to the invention.

In order to ensure a high flexibility with regard to the modification of the properties of the cathode, anode and solid-state electrolyte, it can further be provided according to the invention that the cathode and/or the anode and/or the solid-state electrolyte has a multilayer structure.

For a high chemical and electrochemical stability of a solid-state battery according to the invention, it can be provided that the cathode has a layer thickness of between 50 and 100 μm, in particular between 70 and 90 μm. Preferably, the layer thickness can be >20 μm, more preferably >40 μm, in particular >60 μm.

With regard to a high ion mobility and a wide voltage acceptance range, it can be advantageous if the cathode comprises a lithium compound, preferably in the form of an NMC alloy. In the context of the invention, an NMC alloy is preferably understood to be a lithium-nickel-manganese-cobalt oxide. Advantageously, the cathode can be in the form of a lithium-rich NMC alloy, for example an NMC 333 alloy or NMC 811 alloy. For some NMC-variants, short designations indicating the ratio of nickel, manganese and cobalt are common. For example, LiNi_{0,333}Mn_{0,333}Co_{0,333}O₂ is briefly referred to as NMC 111 or also as NMC 333 and LiNi_{0,8}Mn_{0,1}Co_{0,1}O₂ as NMC 811. Further, in addition to lithium, nickel, manganese, cobalt and oxygen, the cathode may also comprise sulphur. Preferably, the cathode may be used in solid state batteries with a capacity greater than 200 mAh/g.

With regard to a stable and durable structure for ensuring unhindered ion mobility, it can be advantageous if the anode has a layer thickness of between 1 and 10 μm, preferably between and 7 μm. Advantageously, the layer thickness here can be <40 μm, preferably <20 μm, in particular <10 μm.

With regard to an effectively operable solid-state battery that can be adapted to individual needs, it can also be provided that the anode comprises graphite and/or lithium and/or silicon. Thus, the anode, in particular within the scope of an embodiment of a lower capacity of up to 230 kWh/kg, can be designed, for example, in the form of a pure graphite electrode. In the context of a somewhat higher capacity, on the other hand, it may make sense to use a silicon-doped graphite electrode. Furthermore, in the context of a particularly high capacity of, for example, more than 650 Wh/kg, it is conceivable to use a pure lithium electrode, in particular a 3D-lithium-electrode.

In the context of an optimal adaptability of the surfaces of the interfaces between the electrodes and the solid-state electrolyte, it can be advantageously provided according to the invention that in that the solid-state electrolyte has a layer thickness of between 1 and 10 μm, preferably between 3 and 5 μm.

In the context of ensuring a high electrical conductivity, it can also be provided that the solid-state electrolyte is in the form of an oxide, wherein the oxide preferably comprises lithium.

The solid-state electrolyte can, for example, be in the form of LGPS, e.g. Li₁₀GeP₂S₁₂ or LLZO, e.g. Li₇La₃Zr₂O₁₂. In addition to a high Li⁺-content, a wide electrochemical stability range of 1 to 5 V can be achieved by using such suitable electrolyte materials, with or without interfaces to the active material.

In order to optimize the contact between the electrode structures and the solid-state electrolyte and to create an optimum interfacial structure between the layers, it can further be provided that at least one contact layer is provided for improving a contact, wherein the contact layer preferably is arranged between the cathode and the solid-state electrolyte and/or between the anode and the solid-state electrolyte, wherein the contact layer in particular comprises a lithium compound. The contact layer or contact layers can thereby be formed in particular in the form of a lithium alloy.

It is also an object of the invention to provide a motor vehicle, in particular an electric vehicle, comprising a solid-state battery as described above. Thus, the solid-state battery according to the invention offers the same advantages as have already been described in detail with reference to the method according to the invention. It is understood that an electric vehicle can also be understood to mean a hybrid vehicle or the like.

Further advantages, features and details of the invention will be apparent from the following description, in which embodiments of the invention are described in detail with reference to the drawings. The features mentioned in the claims and in the description may be essential to the invention individually or in any combination.

It shows schematically:

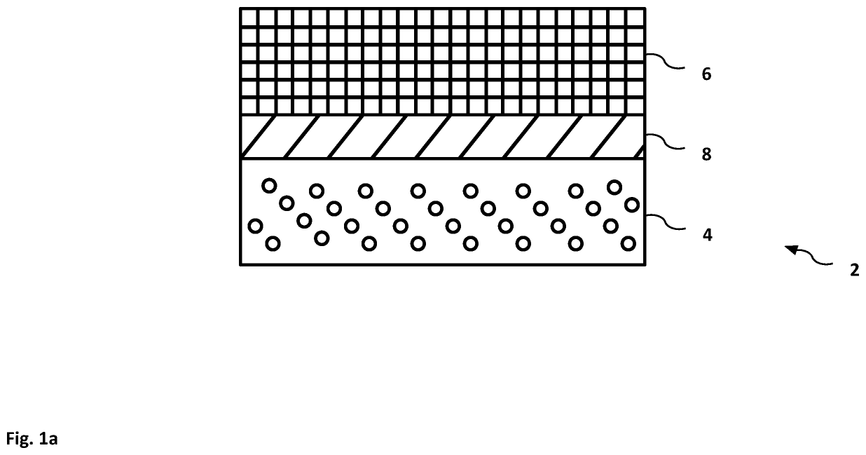

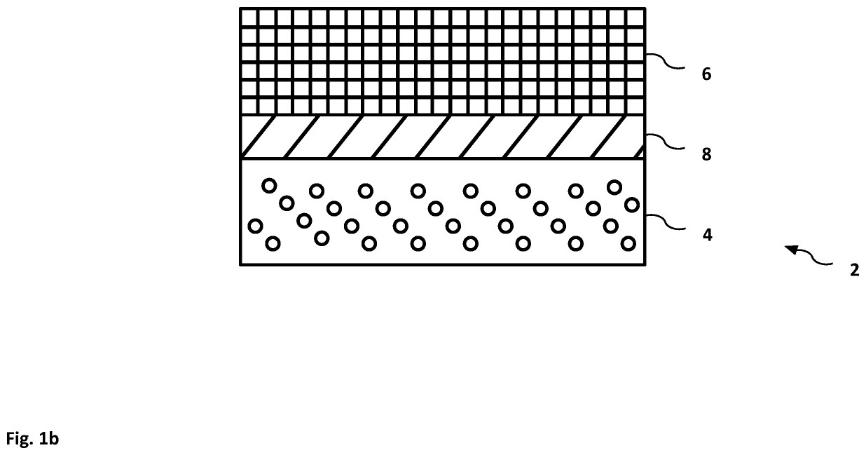

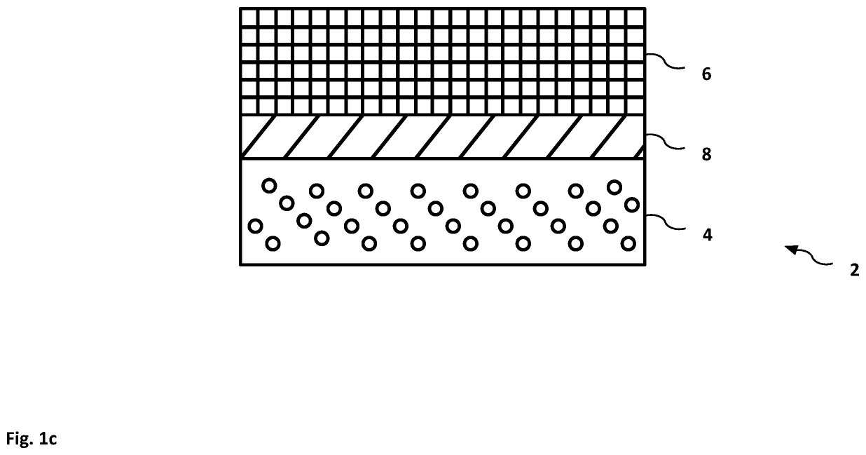

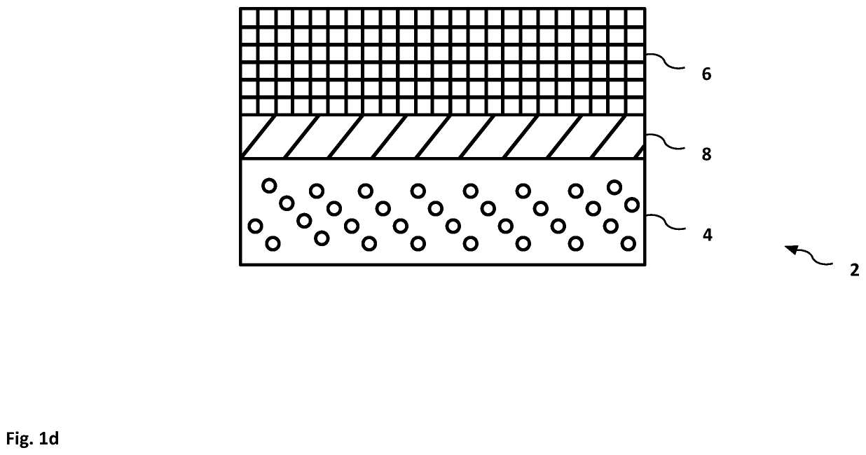

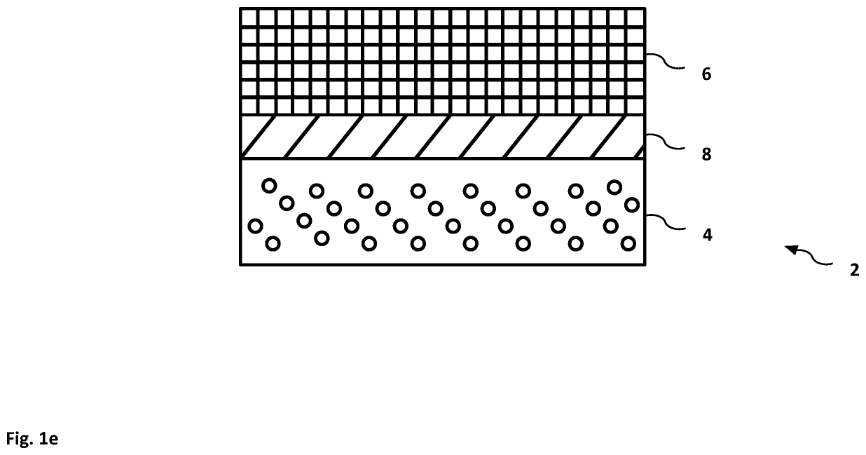

FIG. 1a a first embodiment of a solid-state battery according to the invention,

FIG. 1b a second embodiment of a solid-state battery according to the invention,

FIG. 1c a third embodiment of a solid-state battery according to the invention,

FIG. 1d a fourth embodiment of a solid-state battery according to the invention,

FIG. 1e a fifth embodiment of a solid-state battery according to the invention,

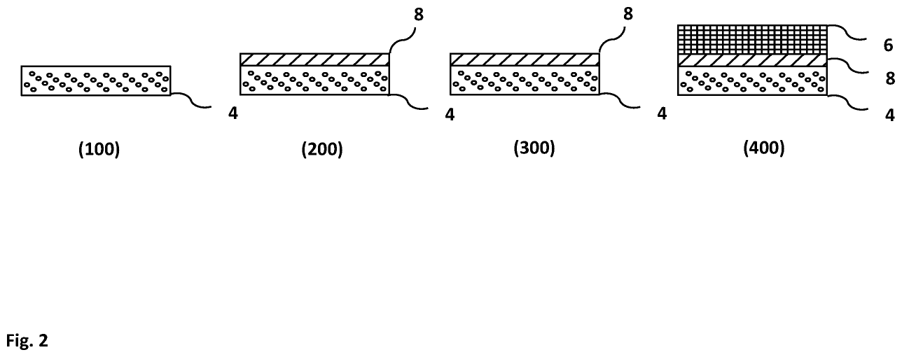

FIG. 2 the individual steps of a method according to the invention for manufacturing a solid-state battery in accordance with a first embodiment.

FIG. 1a shows a first embodiment of a solid-state battery 2 according to the invention which should provide an energy density of about 230 kWh/kg.

As can be seen from FIG. 1a, solid-state battery 2 according to the invention comprises a cathode 4, an anode 6, and a solid-state electrolyte 8 disposed between the cathode 4 and the anode 6. The solid-state electrolyte 8 hereby is in the form of a PVD coating structure.

According to the first embodiment, the cathode 4 is made of NMC, in particular of NMC 333, wherein the Anode 6 is made of graphite. The solid-state electrolyte is further made of a Lithium compound according to the first embodiment, in particular made of sulphide-based electrolyte such as LPS. NMC cathode particles may also be coated with the same electrolyte.

FIG. 1b shows a second embodiment of a solid-state battery 2 according to the invention which should provide an energy density of about 350 kWh/kg.

According to the second embodiment, the cathode 4 is made of NMC, in particular of NMC 811, wherein the Anode 6 is made of a combination of graphite and silicon. The solid-state electrolyte according to the second embodiment may also be made of a Lithium compound.

FIG. 1c shows a third embodiment of a solid-state battery 2 according to the invention which should provide an energy density of about 500 kWh/kg.

According to the third embodiment, the cathode 4 is made of NMC 811, wherein the Anode 6 is made of 3D-Lithium anode. The solid-state electrolyte according to the third embodiment thereby may also be made of a Lithium compound.

FIG. 1d shows a fourth embodiment of a solid-state battery 2 according to the invention which should provide an energy density of about 200 kWh/kg.

According to the fourth embodiment, the cathode 4 is made of NMC 811, wherein the Anode 6 is made of 3D-Lithium anode. The solid-state electrolyte according to the fourth embodiment thereby is also made of a Lithium compound, in particular of LLZO.

FIG. 1e shows a fifth embodiment of a solid-state battery 2 according to the invention which should provide an energy density of about 200 kWh/kg.

According to the fifth embodiment, the cathode 4 is made of NMC 811, wherein the Anode 6 is made of graphite. The solid-state electrolyte according to the fifth embodiment thereby is made of LLZO as well.

The cathode 4 and/or the anode 6 and/or the solid-state electrolyte 8 may be prepared in form of a multilayer structure, wherein the cathode 4 may have a layer thickness of between 50 and 100 μm, preferably between 70 and 90 μm.

However, the anode 6 may have a smaller layer thickness of between 1 and 10 μm, preferably between 5 and 7 μm

Furthermore, the solid-state electrolyte 8 may have a smaller layer thickness of between 1 and 10 μm, preferably between 3 and 5 μm.

What is not apparent from the illustrations in FIGS. 1a to 1e is that, in addition to the anode 4, cathode 6 and solid-state electrolyte 8, at least one contact layer 10 may also be provided for improving a contact between the electrodes 4, 6 and the solid-state electrolyte 8.

FIG. 2 shows the individual steps of a method according to the invention for manufacturing a solid-state battery 2 in accordance with a first embodiment.

As can be seen from FIG. 2, the method according to the invention method according to the invention comprises the steps of preparing 100 a cathode 4, preparing 400 an anode 6, and preparing 200 a solid-state electrolyte 8 to be disposed between the cathode 4 and the anode 6, wherein the solid-state electrolyte 8 is prepared by means of a coating process, wherein the coating process comprises PVD coating.

As can be seen from FIG. 2, the cathode 4, the solid-state electrolyte 8 and the anode 6 are prepared one after another, wherein the cathode 4, the solid-state electrolyte 8 and the anode 6 preferably each being prepared by means of an application process, wherein the cathode 4 is applied first, before the solid-state electrolyte 8 is applied on the cathode 4 and the anode 6 is then applied on the solid-state electrolyte 8.

Prior to the last step of applying the anode on the solid-state electrolyte 8, a post-processing step 300 takes place, wherein the post-processing step 300 may comprise a microalloying and/or a stoichiometric tuning and/or a microstructural tuning and/or a metastable phase formation.

The above explanation of the embodiments describes the present invention exclusively in the context of examples. Of course, individual features of the embodiments can be freely combined with each other, provided that this is technically sensible, without leaving the scope of the present invention.

### LIST OF REFERENCE SIGNS

2 Solid-state battery
4 Cathode
6 Anode
8 Solid-state electrolyte
10 Contact layer
100 Preparing a cathode
200 Preparing a solid-state electrolyte
300 Postprocessing
400 Preparing an anode

1. A method for manufacturing a solid-state battery comprising:
preparing a cathode,
preparing an anode,
preparing a solid-state electrolyte to be disposed between the cathode and the anode,
wherein the solid-state electrolyte is prepared by means of a coating process, wherein the coating process comprises PVD coating.

2. The method according to claim 1, wherein the cathode is prepared by a thermal deposition process.

3. The method according to claim 1, wherein the anode is prepared by a PVD coating process.

4. The method according to claim 1, wherein the method comprises preparing at least one contact layer for improving a contact at least between the cathode and the solid-state electrolyte between the anode and the solid-state electrolyte.

5. The method according to claim 1, wherein the contact layer is prepared by means of a PVD coating process.

6. The method according to claim 1, wherein the cathode, the solid-state electrolyte and the anode are prepared one after another.

7. The method according to claim 1, wherein the method comprises at least one post-processing stage.

8. The method according to claim 1, wherein the method comprises different deposition techniques, combining thin film deposition techniques and thick film deposition techniques, wherein the method comprises at least one of a spray deposition technique or an arc deposition technique or a magnetron sputter deposition technique or a reactive PVD deposition technique or a pulsed laser deposition technique or a hot calendering technique.

9. The solid-state battery produced by a process according to claim 1, comprising:
the cathode,
the anode,
the solid-state electrolyte disposed between the cathode and the anode, wherein the solid-state electrolyte is in the form of a PVD coating structure.

10. The solid-state battery according to claim 9, wherein at least one of the cathode or the anode or the solid-state electrolyte has a multilayer structure.

11. The solid-state battery according to claim 9, wherein the cathode has a layer thickness of between 50 and 100 μm.

12. The solid-state battery according to claim 9, wherein the cathode comprises a lithium compound.

13. The solid state battery according to claim 9, wherein the anode has a layer thickness of between 1 and 10 μm.

14. The solid state battery according to claim 9, wherein the anode comprises at least graphite or lithium or silicon.

15. The solid-state battery according to claim 9, wherein the solid-state electrolyte has a layer thickness of between 1 and 10 μm.

16. The solid-state battery according to claim 9, wherein the solid-state electrolyte is in the form of an oxide.

17. The solid-state battery according to claim 9, wherein at least one contact layer is provided for improving a contact.

18. A motor vehicle comprising a solid-state battery according to claim 9.

19. The method according to claim 6, wherein the cathode, the solid-state electrolyte and the anode each being prepared by an application process, the cathode being applied first, before the solid-state electrolyte is applied on the cathode and the anode is then applied on the solid-state electrolyte.

20. The method according to claim 7, wherein the method comprises at least one post-processing stage, wherein the post-processing stage comprises at least one of the following:
a microalloying,
a stoichiometric tuning,
a microstructural tuning,
a metastable phase formation.
